(19) United States
(12) Patent Application Publication
(10) Pub. No.: US 2009/0057454 A1
(43) Pub. Date: Mar. 5, 2009

(54) Disc Housing

(75) Inventors: Orjan Ahlgren, Sundsvall (SE); Anders Mattsson, Alno (SE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Metso Panelboard AB, Sundsvall (SE)

(21) Appl. No.: 11/887,987

(22) PCT Filed: Apr. 6, 2006
(86) PCT No.: PCT/SE2006/000413

§ 371 Date: Oct. 5, 2007

(30) Foreign Application Priority Data
Apr. 18, 2005 (SE) 0500892-5

(51) Int. Cl. B02C 7/11; D21D 1/30

(52) U.S. Cl. 241/245; 162/261; 241/260; 241/261.2

(57) ABSTRACT

A disc housing intended for refiners with refining discs rotating in opposed directions relative to each other is disclosed for mechanically disintegrating and working fibrous material. The disc housing surrounds the refining discs in an air-tight manner, and is provided with an outlet for the worked fibrous material. The inside of the disc housing alond its periphery is formed with a channel, which, as seen in the circumferential direction, has a continously increasing radius, which increases all the way to the outlet, which is located tangentially as a direct continuation of the channel.

This invention relates to refiners of disc-type with refining discs rotating in opposite directions relative to each other. The refining discs are provided with refining segments, which between themselves form a refining gap with a refining zone for the mechanical disintegration and working of fibrous material, which preferably is lignocellulosic. The refining gap is used for the manufacture of, for example, reject pulp, recycled fibre pulp and mechanical pulps such as board pulp, thermomechanical pulp (TMP) and chemithermomechanical pulp (CTMP). The refining discs are surrounded by an air-tight disc housing, which allows the fibrous material to be fed in centrally through one of the refining discs. After its passage through the refining gap the worked material flows out into the disc housing, from where it is led further via a blow valve to subsequent process stages.

The mechanical disintegration and working of the material requires energy, which is supplied via the refining elements on the refining discs. The supplied energy transforms at the refining work substantially to heat, with the result that the water following along with the material evaporates and emits from the worked material. The main part of the steam flows out into the disc housing where a pressure is maintained by means of the blow valve.

Due to the rotation of the refining disc, the worked material will be thrown about in the disc housing before the material together with the steam leaves the disc housing through the blow valve. This turbulent flow of the fibrous material in the disc housing increases the energy consumption and causes wear on the rotating as well as the stationary parts of the disc housing. Fibre build-up and extractive matter on the inside of the disc housing brake the flow and can block the outflow through the blow valve, which results in higher energy consumption and increases the steam development.

The present invention relates to a disc housing for refiners which is designed to overcome the aforesaid problems and improve the fiber flow in the disc housing.

The inside of the disc housing, therefore, along its periphery is formed with a channel, the radius of which increases continuously in the circumferential direction outside the opening of the refining gap in the disc housing. The radius shall increase continuously all the way to the outlet to the blow valve. This outlet shall be located tangentially so that it is a direct continuation of the channel. The disc housing suitably can be designated with the channel as an all around widening outside the opening of the refining gap in the disc housing. The blow valve can be formed with an adjustable opening only directly in front of the outer portion, radially seen, of said channel.

By this design of the disc housing great advantages are achieved. The material flow out from the refining gap is collected in the disc housing and follows the channel on the inside of the disc housing toward the outlet to the blow valve. The material flow thereby becomes more uniform, and it was found that the energy consumption can be reduced by more than 25-50 kWh/tons of fiber. By concentrating the fiber flow to a channel along the inner periphery of the disc housing, can the wear on the various parts in the disc housing be reduced and the risk of fiber-build-up and disturbances resulting therefrom be decreased. The rotating refining disc (rotator) of the refiner will rotate in a thinner medium, because the fibrous material follows the channel instead of forming a thick atmosphere of steam, water and fiber in the entire disc housing. The design of the blow valve implies that the valve opening can be adopted to the fiber flow in the channel along the periphery of the disc housing. Flow obstacles can be prevented and the risk of clogging thereby be reduced.

A further advantage of the invention at the manufacture of board pulp is, that the uniform flow of fibrous material in the disc housing and out through the blow valve renders possible a better controlled and thereby reduced size addition.

The characterizing features of the invention are apparent from the claims.

The invention is described in greater detail in the following with reference to the accompanying drawings, in which

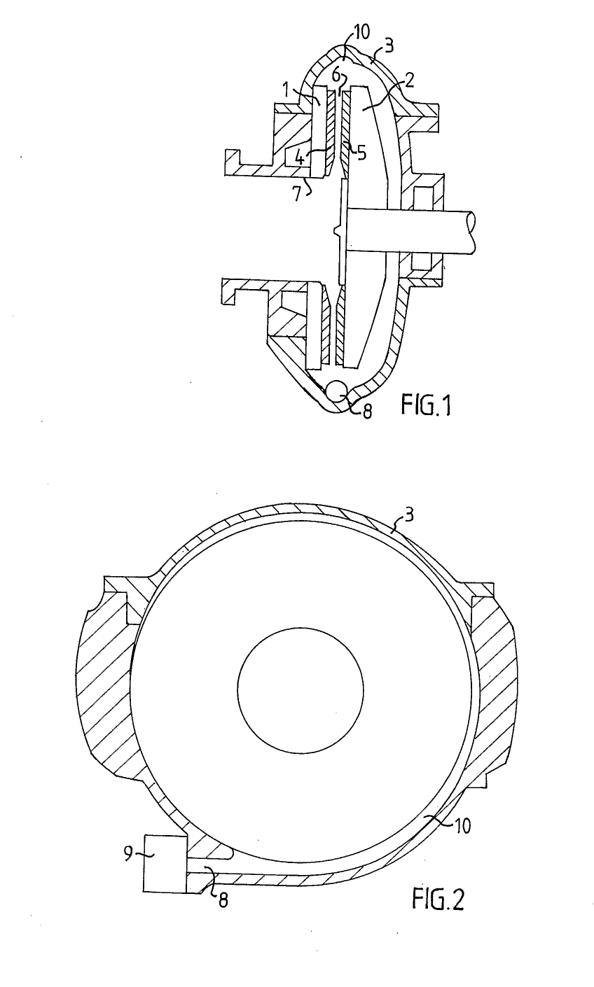

FIG. 1 shows a refiner with a disc housing according to the invention;

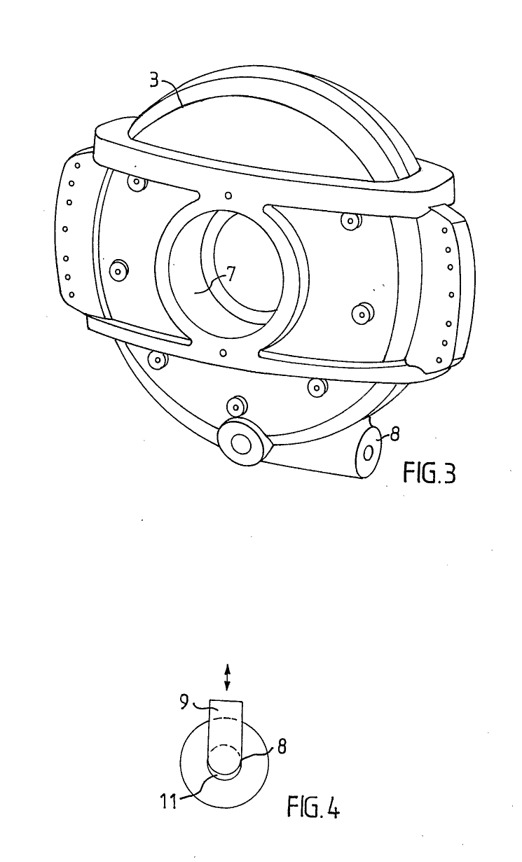

FIGS. 2 and 3 show a disc housing according to the invention by way of cross-section, and, respectively, a view from the outside;

FIG. 4 shows schematically a blow valve for the disc housing.

In FIG. 1 is shown a disc refiner comprising a stationary refining disc (stator) 1 and a rotary refining disc (rotator) 2 mounted in a disc housing 3. Refining segments 4,5 are attached to the stator and rotator, respectively. The refining segments 4,5 form between themselves a refining gap 6. An opening 7 is provided for feeding the fibrous material through the stator 1 to the gap between the refining segments 4,5. The disc housing 3 is provided with an outlet 8 and a blow valve 9 for controlling the pressure in and the flow out of the disc housing. The inside of the disc housing in its periphery is formed with a channel 10, the radius of which in the circumferential direction increases continuously outside the opening of the refining gap 6 in the disc housing 3. The channel 10 extends along at least through half the circumference in the disc housing all the way to the outlet 8. The channel 10 suitably is located directly in front of the refining gap 6 between the refining segments 4,5. The outlet 8 is located tangentially as a direct continuation of the channel 10. The channel 10 in the disc housing suitably is formed, seen in cross-section, with a rounded bottom. The channel thereby is formed as a widening in the circumference of the disc housing.

The blow valve 9 suitably is formed with an adjustable opening 11 only directly in front of the radially seen outer portion of the channel 10. The valve is provided with a slidable or rotary cover, which can cover the cross-section of the valve opening and leave an adjustable gap opening in only the outer portion of the cross-section.

The fibrous material, for example in the form of wood chips to be disintegrated and worked in the refiner, is supplied through the opening 7 in the disc housing 3 and stator 1, suitably by means of a screw feeder (not shown). The fibrous material is treated thereafter in the refining gap 6 where it is disintegrated and worked to fiber pulp in the refining gap 6 between the refining segments 4,5 rotating in opposed directions and flows out into the disc housing. The rotation of the rotor 2 and the centrifugal force cause the fiber pulp to be collected in and be transported along the channel 10. Due to the design of the channel, the pulp will be moved to the outlet 8 as a uniform flow and does not gyrate about in the disc housing. As mentioned above, this implies that the energy consumption of the refiner can be reduced essentially and the quality of the pulp be improved. Furthermore, the wear on the parts in the disc housing decreases and the risk of fiber build-up and clogging is reduced.

The design of the blow valve 9 implies that the pulp flow out through the valve is facilitated, because the gap-shaped opening 11 can be adapted to the pulp flow along the bottom of the channel 10.

The invention, of course, is not restricted to the embodiments shown, but can be varied within the scope of the claims with reference to the description and Figures.

1-3. (canceled)

4. A refiner housing including a pair of relatively rotatable refiner discs juxtaposed with each other therein for refining fibrous material therebetween, said refiner housing including an outer periphery, an outlet for said refined fibrous material tangential to the inner surface of said outer periphery of said refiner housing, a channel formed within said outer periphery of said refiner housing, said channel having a continuously increasing radius along its circumferential direction up to a maximum radius at said outlet, and a blow valve associated with said outlet for controlling the flow of said refined fibrous material out of said refiner housing, said blow valve including an adjustable opening disposed at a location limited to a location directly facing said channel as seen from the radial direction thereof.

5. The refiner housing of claim 4 wherein said continuously increasing radius along the circumferential direction of said channel comprises a widening channel within said outer periphery of said refiner housing.

6. The refiner housing of claim 4 wherein said channel includes a rounded base portion.
